(19) United States
(12) Patent Application Publication
(10) Pub. No.: US 2007/0152831 A1
(43) Pub. Date: Jul. 5, 2007

(54) 3-axis RFID tag antenna

(76) Inventor: Sean Eisele, New York, NY (US)

Correspondence Address: INTEL CORPORATION;c/o INTELLEVATE, LLC, P.O. BOX 52050, MINNEAPOLIS, MN, 55402, US

(21) Appl. No.: 11/521,816

(22) Filed: Sep. 15, 2006

Related U.S. Application Data
(63) Continuation-in-part of application No. 11/327,126, filed on Jan. 5, 2006.

(51) Int. Cl. G08B 13/14

(52) U.S. Cl. 340/572.7

(57) ABSTRACT

A radio frequency identification (RFID) tag with three antennas may be disposed on a label, with the shape of the label and the arrangement of the antennas being such that when the label is properly attached to a rectangular object, each of the antennas will be orthogonal to the other two. In this way, the box may be set on any of its sides (e.g., on a conveyor belt), and at least two antennas will still be properly oriented for reading by a pre-positioned RFID reader.

### REFERENCE TO RELATED INVENTIONS

This is a continuation-in-part (CIP) of U.S. patent application Ser. No. 11/327,126, filed Jan. 5, 2006, and claims priority to that filing date for all common subject matter.

### BACKGROUND

The use of radio frequency identification (RFID) technology is becoming increasingly widespread, largely due to the fact that the most common version of RFID tags can operate without an internal power source, instead using power scavenged from a received RF signal. However, this need for extremely low-power operation has limited the complexity and operational versatility of conventional RFID tags. In particular, the orientation of the antenna on an RFID tag can make a difference in whether the RFID tag is even detectable by the RFID reader.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows an RFID system using orthogonal antennas, according to an embodiment of the invention.

FIG. 2 shows another RFID system using orthogonal antennas, according to an embodiment of the invention.

FIG. 3 shows an RFID system using orthogonal polarization for communication between other devices, according to an embodiment of the invention.

FIG. 4 shows a flow diagram of a method of communicating with RFID tags that have orthogonally polarized communications and with those that do not, according to an embodiment of the invention.

FIG. 5 shows an RFID tag with three antennas configured such that at least two antennas may be oriented for operation with a reader, according to an embodiment of the invention.

FIG. 6 shows another RFID tag with three antennas configured such that at least two antennas may be oriented for operation with a reader, according to an embodiments of the invention.

FIG. 7 shows a flow diagram of a method of placing the RFID tag of FIG. 5 or 6 onto an object.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description. References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

The term “processor” may refer to any device or portion of a device that processes electronic data from registers and/or memory to transform that electronic data into other electronic data that may be stored in registers and/or memory. A “computing platform” may comprise one or more processors.

An RFID reader may be used to transmit a signal to an RFID tag, and to receive the response signal transmitted by the RFID tag. Within the context of this document, an RFID tag may be defined as comprising at least one RFID antenna (to receive an incoming signal that serves to query the RFID tag and to transmit a response in the form of a modulated radio frequency signal), and an RFID tag circuit (which may include circuitry to store an identification code for the RFID tag, circuitry to transmit that code through the at least one antenna, and in some embodiments a power circuit to collect received energy from the incoming radio frequency signal and provide that energy to power the operations of the RFID tag circuit). As is known in the field of RFID technology, “transmitting” a signal from an RFID tag may, depending on the type of RFID tag, include either: 1) providing sufficient power to the antenna to generate a signal that radiates out from the antenna, or 2) reflecting a modulated version of the received signal. In some embodiments, the signal from the RFID reader may selectively address a particular RFID tag, so that only the selected tag will respond.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Various embodiments of the invention may be implemented in one or any combination of hardware, firmware, and software. The invention may also be implemented as instructions contained in or on a machine-readable medium, which may be read and executed by one or more processors to perform the operations described herein. A machine-readable medium may include any mechanism for storing, transmitting, and/or receiving information in a form readable by a machine (e.g., a computer). For example, a machine-readable medium may include a storage medium, such as but not limited to read only memory (ROM); random access memory (RAM); magnetic disk storage media; optical storage media; a flash memory device, etc. A machine-readable medium may also include a tangible medium, which may include the aforementioned storage medium and/or a tangible device through which electrical, optical, acoustical or other form of propagated signals representing the instructions may pass, such as an antenna, optical fiber, communications interface, etc. A machine-readable medium may also include the propagated signal itself which has been modulated to encode the instructions.

Various embodiments of the invention may comprise use of two orthogonally polarized antennas on an RFID device. Polarization of the signals may be circular, or vertical/horizontal (where vertical/horizontal implies perpendicular with respect to each other—not necessarily vertical/horizontal with respect to gravity). This polarization may permit communication techniques such as but not limited to: 1) improve the signal-to-noise ratio (SNR) by transmitting and/or receiving the same signal on both antennas, 2) simultaneously transmitting or receiving different data on each antenna to increase overall data rate, 3) transmitting on one antenna while simultaneously receiving on another antenna for full duplex operation, 4) etc. ‘Simultaneously’ implies that at least a portion of the two actions takes place at the same time, although each action may have a different start and/or end time than the other action.

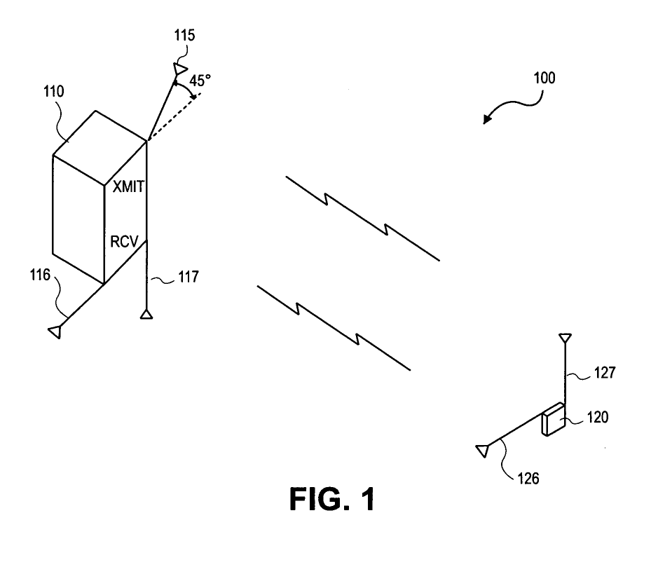

FIG. 1 shows an RFID system using orthogonal antennas, according to an embodiment of the invention. In system 100, an RFID tag may include RFID tag circuit 120 (along with related supporting structure), and two antennas 126 and 127, oriented at approximately right angles to each other. (Note: the term “approximately” may be used throughout this document with terms such as “right angles”, “orthogonal”, “parallel”, etc., because in the physical world, exactness of these relationships may not be feasible or even achievable. The term “approximately” is used herein to indicate that embodiments of the invention may encompass this inexactness.) System 100 also includes an RFID reader 110 with antennas 116 and 117 that are oriented at approximately right angles to each other. Further, antenna 116 may be oriented in approximately the same direction as antenna 126, while antenna 117 may be oriented in approximately the same as antenna 127, so that communications between antennas 116 and 126 are polarized in the same direction and communications between antennas 117 and 127 are polarized in the same direction. For the purposes of this example, antennas 116 and 126 may be considered to have a horizontal polarization, while antennas 117 and 127 may be considered to have a vertical polarization. As used herein, these terms simply imply that like-named antennas are oriented the same with respect to each other, but may not necessarily have any particular orientation with respect to gravity.

RFID reader 110 may also have another antenna 115. In some embodiments, antenna 115 may be used to transmit signals from the RFID reader to the RFID tag, while antennas 116 and 117 may be used to receive signals from the RFID tag. In the example of FIG. 1, the RFID tag and the RFID reader are oriented such that antennas 116 and 126 are polarized in approximately the same direction as each other, while antennas 117 and 127 are polarized in approximately the same direction as each other but at approximately a right angle to antennas 116 and 126. Further, in the example shown, antenna 115 may be oriented such that it is polarized at approximately a 45 degree angle between antennas 116 and 117. In this position, a signal transmitted from antenna 115 may still be strong enough in either polarization to be received by both antenna 126 and antenna 127. Conversely, a signal transmitted by antenna 126 may be strong enough (due to proper polarization) for reception by antenna 116, but too weak (due to improper polarization) for reception by antenna 117. Similarly, a signal transmitted by antenna 127 may be strong enough (due to proper polarization) for reception by antenna 117, but too weak (due to improper polarization) for reception by antenna 116.

Using the embodiment shown in FIG. 1, an RFID reader may transmit a signal (e.g., from antenna 115) to an RFID tag (e.g., to antennas 126, 127) that energizes the RFID tag (through power scavenged from the received signal), and also causes the RFID tag to transmit a response back to the RFID reader. The RFID tag may transmit through: 1) antenna 126 but not antenna 127, 2) antenna 127 but not antenna 126, 3) both antennas, with the same signal, 4) both antennas, with different signals. Further, the RFID reader may receive through antenna 116 the signal (if any) transmitted from antenna 126, and may receive through antenna 117 the signal (if any) transmitted from antenna 127. In some embodiments the selection of antenna(s) that the RFID tag uses for transmission may be determined by information in the signal transmitted from the RFID reader.

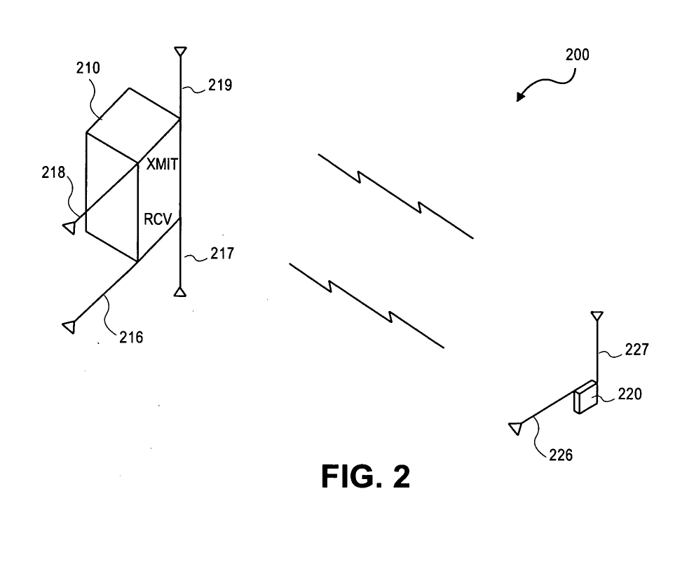

FIG. 2 shows another RFID system using orthogonal antennas, according to an embodiment of the invention. In system 200, the RFID tag circuit 220, antenna 226, and antenna 227 may correspond generally with the RFID tag circuit 120, antenna 126, and antenna 127 of FIG. 1. RFID reader 210 may have receive antennas 216 and 217 oriented at approximately right angles to each other, and may also have transmit antennas 218 and 219 oriented approximately at right angles to each other. Further, the RFID tag may be oriented such that antenna 226 is polarized approximately the same as antennas 216 and 218, while antenna 227 is polarized approximately the same as antennas 217 and 219.

In some embodiments, the RFID reader may transmit a signal from antenna 218 that, due to relative polarization, is received by the RFID tag through antenna 226 but not through antenna 227. Similarly, the RFID reader may transmit a signal from antenna 219 that, due to relative polarization, is received by the RFID tag through antenna 227 but not through antenna 226. Thus, different signals may be transmitted separately and simultaneously from antennas 218 and 219, and those different signals may be received separately and simultaneously through antennas 226 and 227, respectively. Conversely, different signals may be transmitted separately and simultaneously from antennas 226 and 227, and those different signals may be received separately and simultaneously through antennas 216 and 217, respectively.

The resulting use of orthogonally polarized signals may effectively create two separate channels, which may be used in various ways, such as but not limited to the following:

A. Faster data transmission—part of the data transmitted from the RFID reader to the RFID tag may be transmitted from antenna 219 to antenna 227. Simultaneously, another part of the data transmitted from the RFID reader to the RFID tag may be transmitted from antenna 218 to antenna 226. These two parts of the data may be separated within the RFID reader before transmission and reassembled after reception by the RFID tag. Thus the total data rate that is possible from reader to tag may be effectively doubled over the data rate that would be possible without orthogonal polarization. In a similar manner, the data rate of transmissions from the RFID tag to the RFID reader may be increased through the use of orthogonal polarization.

B. Full duplex communications—the RFID reader may transmit a signal from antenna 219 that is received by the RFID tag through antenna 227. Simultaneously, the RFID tag may transmit a signal from antenna 226 that is received by the RFID reader through antenna 216, thus permitting full duplex communications between the two devices.

C. Improved signal-to-noise ratio (SNR)—The transmitting device may transmit the same signal through two orthogonally polarized antennas simultaneously, either exactly at the same time or with a relative delay in one. Similarly, the receiving device may receive the same signal through both antennas. The two received signals may be handled in various ways, such as but not limited to: 1) select the signal with the best reception and ignore the other, 2) combine the two signals in some manner to overcome errors in one, 3) compare the data encoded in the two signals and select the one with no (or with correctible) errors, 4) etc.

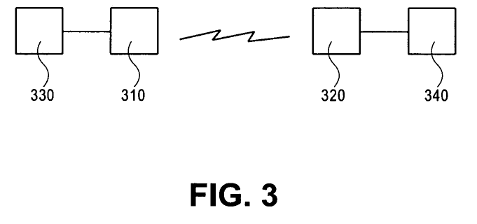

FIG. 3 shows an RFID system using orthogonal polarization for communication between other devices, according to an embodiment of the invention. In the illustrated embodiment, an RFID tag 320 may act as a radio transceiver for another electronic device 340. Device 340 may have a robust power source and thus be able to support extensive processing and other operations, but use an RFID tag for wireless communications. Similarly, RFID reader 310 may act as a transceiver for electronic device 330, which may also provide more extensive processing and/or other functions not included in the RFID reader. Alternately, such extensive processing, etc., may reside in the RFID reader, which may provide its own wireless capability. The particular communications techniques may include any of those mentioned herein, such as the full duplex technique previously described.

The examples previously given assumed that both the RFID reader and the RFID tag included orthogonally polarized communications in the form of multiple antennas on both the reader and the tag. However, it is possible that in operation, an RFID reader may be expected to communicate both with RFID tags that have orthogonal polarization capability and RFID tags that do not. Further, those tags that do have such capability may be able to support only a limited set of the operations made possible by orthogonally polarized communications.

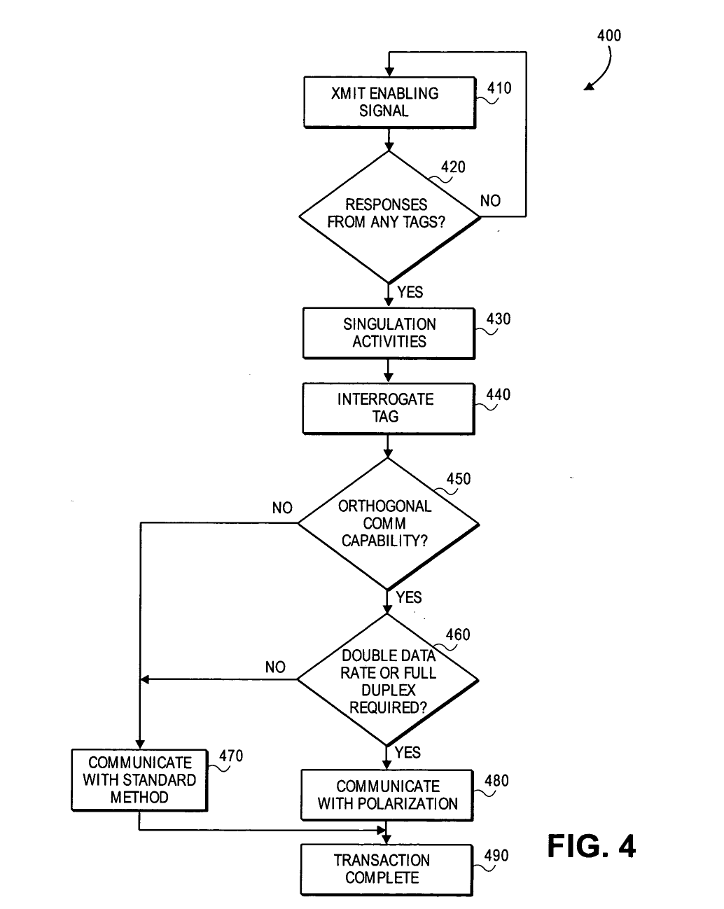

FIG. 4 shows a flow diagram of a method of communicating with RFID tags that have orthogonally polarized communications and with those that do not, according to an embodiment of the invention. In some embodiments the method of flow diagram 400 may be performed in an RFID reader. At 400, an enabling signal may be sent from the RFID reader to RFID tags within range of that signal. Such a signal may be configured for reception and response by both single- and multi-antenna RFID tags. The tags that are able to do so may respond at 420. If no tags respond, the enabling signal may continue to be transmitted (as shown), or the enabling signal may be terminated after a suitable period (not shown). If multiple RFID tags respond, the RFID reader may perform singulation with those tags (isolating communication to a single tag) at 430 so that the RFID reader may then communicate directly with a single tag and the other RFID tags will not transmit. Various techniques of singulation are known and are not further discussed in detail herein.

At 440 the RFID reader may interrogate the RFID tag that was singulated, requesting that tag to respond in a particular manner. In some embodiments, the response will include information that indicates whether the responding tag has the capability for orthogonally polarized communications. For example, a tag with such capability may place certain data in the response, while a tag without such capability would not. Alternatively, a tag with such capability may respond with orthogonally polarized signals, thus showing such capability without having to insert specific data in the response. Regardless of the method used to indicate such capability, processing may branch at 450 depending on the indication. If the tag does not indicate orthogonal polarization capability, the reader may proceed to communicate with the tag at 470 using standard RFID communication techniques. If the tag does indicate such capability, the reader may further determine at 460 which specific capabilities the tag has. In some embodiments, such determination may be made through a further query-response operation. In other embodiments, such determination may be made from the response to the interrogation at 440. Regardless of the technique used, the RFID reader may proceed to communicate with the RFID tag at 480, using the orthogonal polarization techniques that were indicated. Once the transaction is complete at 490, the operation may be terminated. Communication with another RFID tag may then be initiated (not shown).

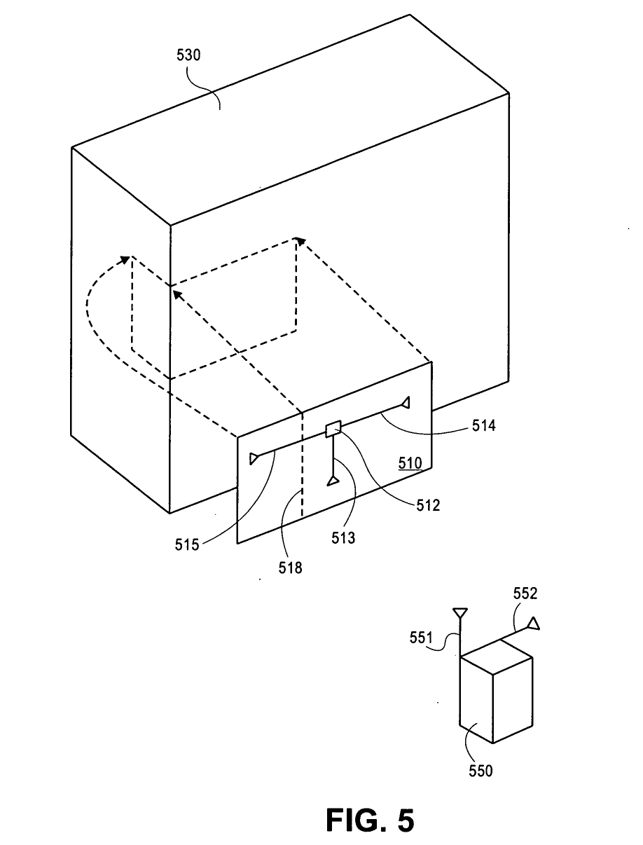

FIG. 5 shows an RFID tag with three antennas configured such that at least two antennas may be oriented for orthogonal operation with a reader, according to an embodiment of the invention. In the illustrated example, a planar substrate 510 may have an RFID tag 512 with three RFID tag antennas 513, 514, and 515 disposed thereon. In some embodiments, the substrate may be a flexible material (such as a paper label, for example) that may be folded along a line indicated at 518. In other embodiments the substrate may be a more rigid material that has been configured for folding it into a right-angle along the line 518. In still other embodiments, the substrate may be constructed with the bend at 518 already in place. Other embodiments may use other techniques. Regardless of the type of substrate used, in various embodiments the substrate may be attached to a container 530 in a manner that places antennas 513 and 514 on one surface of the container, while the antenna 515 is on an adjacent surface of the container, such that antennas 513, 514, and 515 are approximately orthogonal to each other. Attachment of the substrate to the container may use any feasible technique, such as adhesive. In still other embodiments, the RFID tag and antennas may be built into the container itself when the container is manufactured.

The finished assembly of the container 530 with attached substrate 510 on two adjacent surfaces may be used to advantage on conveyer belts on which the containers pass by an RFID reader, such as RFID reader 550. Because the container will have three orthogonally-oriented antennas, as long as one of the container's surfaces is facing towards RFID reader 550, at least two antennas on the RFID tag may be oriented such that they may communicate with the reader with orthogonally polarized signals. The axis of the third antenna may be oriented such that it is not useful, but two antennas may be enough for reliable communication. Thus, a rectangular container may not have to be placed on the conveyer belt with any particular orientation for the dual antenna techniques to be used, as long as one surface of the container is approximately facing the orthogonally polarized RFID reader antennas 551 and 552.

If the containers are always oriented with a particular face towards the RFID reader 550, then antenna 515, as well as the fold at 518, may be eliminated and the substrate 510 may be attached to that particular face of the container with the antennas 513 and 514 oriented vertically and horizontally, thus providing the correct polarization for the operations with RFID reader 550 previously described.

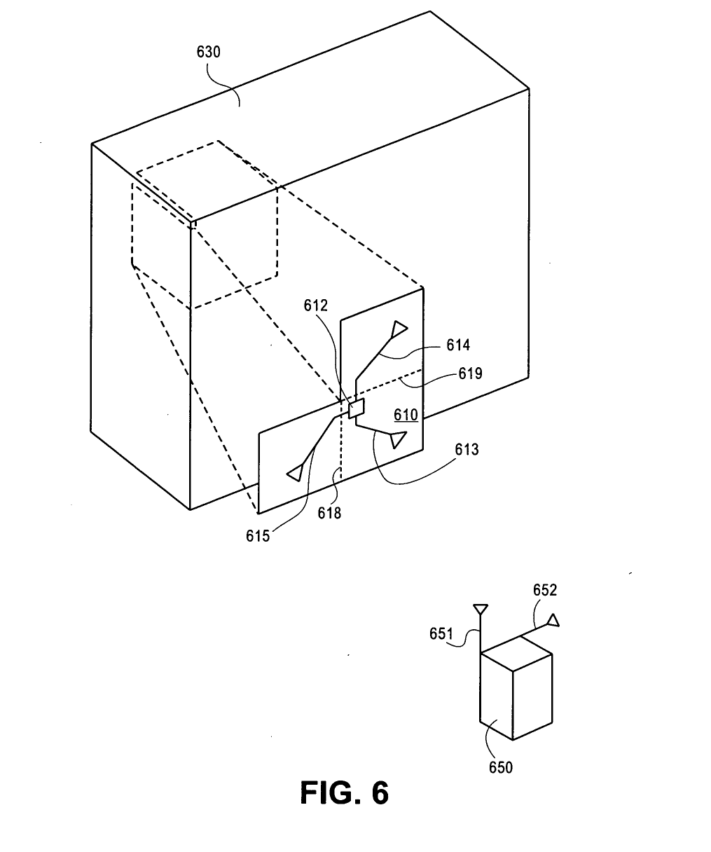

FIG. 6 shows another RFID tag with three antennas configured such that at least two antennas may be oriented for reliable operation with an RFID reader, according to an embodiment of the invention. The element numbers of FIG. 6 correspond generally with the element numbers of FIG. 5, except the numbers 5xx have been replaced with numbers 6xx. A primary difference between the embodiments of FIGS. 5 and 6 is that the substrate of FIG. 5 has been configured for attachment to two adjacent sides of an object 530 (e.g., a container, although other embodiments may use other objects) by placing the substrate around a single edge of the container (e.g., the substrate may be folded along line 518 to wrap around this edge), while the substrate of FIG. 6 has been configured for attachment to three adjacent sides of the container 630 by placing the substrate around two edges of the container that meet at a common corner (e.g., the substrate may be folded along lines 618 and 619).

Another difference between the illustrated embodiments of FIGS. 5 and 6 pertains to the orientation of the antennas. In the illustrated embodiment of FIG. 5, after attachment of the substrate to the container, the antennas may be oriented approximately in parallel with the edges of the container. In the illustrated embodiment of FIG. 6, after attachment of the substrate to the container, the antennas may be oriented approximately diagonally to the edges of the container 630. However, in other embodiments the diagonal antenna placement shown in FIG. 6 may be combined with the single-edge configuration shown in FIG. 5, while the parallel antenna placement shown in FIG. 5 may be combined with the double-edge configuration shown in FIG. 6.

In some operations the diagonal antenna placement shown in FIG. 6 may be more advantageous. For example, although neither vertical antenna 651 nor horizontal antenna 652 on RFID reader 650 is oriented for maximum signal strength when receiving a signal from diagonal antenna 613, each of antennas 651 and 652 may receive a signal from the diagonal antenna 613 that is sufficiently strong to be usable. In some instances, a single antenna (either vertical or horizontal) on RFID reader 650 may therefore be sufficient to perform acceptably, eliminating the need for dual antennas on the RFID reader 650.

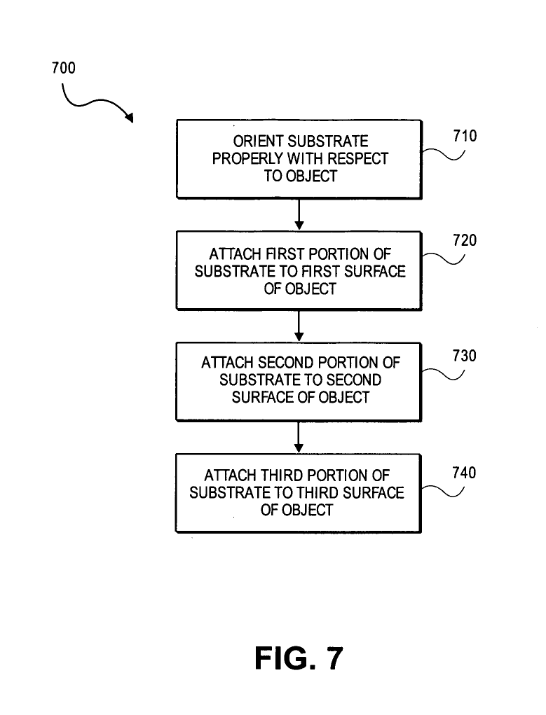

FIG. 7 shows a flow diagram of a method of placing the RFID tag of FIG. 5 or 6 onto an object. In flow diagram 700, the substrate containing the RFID tag circuit and antennas may be oriented for proper attachment to an object, e.g., to a rectangular container. At 720, a first portion of the substrate may be attached to the object. For example, the portion of the substrate containing antenna 613 may be attached a surface close to the upper-left corner of container 630 as shown in FIG. 6. At 730 and 740, the substrate may be folded, bent, etc. so that the second and third portions of the substrate may be attached to adjoining surfaces of the container, for example as shown in FIG. 6. In some embodiments, attachment may be accomplished by pressing an adhesive backing of the substrate against the container, but other embodiments may use other techniques (for example, by stapling the substrate to the container, by using temporary attachment techniques such as magnetic or Velcro© techniques, etc.).

The foregoing description is intended to be illustrative and not limiting. Variations will occur to those of skill in the art. Those variations are intended to be included in the various embodiments of the invention, which are limited only by the spirit and scope of the following claims.

What is claimed is:

1. An apparatus, comprising
planar substrate having a first portion, a second portion, and a third portion;
a radio frequency identification (RFID) tag circuit disposed on the planar substrate;
a first antenna disposed on the first portion and connected to the RFID tag circuit;
a second antenna disposed on the second portion and connected to the RFID tag circuit; and
a third antenna disposed on the third portion and connected to the RFID tag circuit;
wherein the planar substrate is capable of being shaped such that a surface of the first portion, a surface of the second portion, and a surface of the third portion are approximately orthogonal to each other.

2. The apparatus of claim 1, wherein the first, second, and third antennas are disposed on the planar substrate such that the first, second, and third antennas are approximately orthogonal to each other when the first, second, and third portions are approximately orthogonal to each other.

3. The apparatus of claim 1, wherein the planar substrate is comprised of a flexible material capable of being folded along a line between the first and second portions.

4. The apparatus of claim 1, wherein the planar substrate is comprised of a flexible material capable of being folded along a line between the second and third portions.

5. The apparatus of claim 1, further comprising an adhesive material to attach the planar substrate to an object.

6. An apparatus, comprising
an object having first, second, and third surfaces approximately orthogonal to each other;
a planar substrate coupled to the object, the planar substrate having a first portion coupled to the first surface, a second portion coupled to the second surface, and a third portion coupled to the third surface;
a radio frequency identification (RFID) tag circuit disposed on the planar substrate;
a first antenna disposed on the first portion and connected to the RFID tag circuit;
a second antenna disposed on the second portion and connected to the RFID tag circuit; and
a third antenna disposed on the third portion and connected to the RFID tag circuit;
wherein the first, second, and third antennas are approximately orthogonal to each other.

7. The apparatus of claim 6, wherein the planar substrate is coupled to the object with an adhesive material.

8. The apparatus of claim 6, wherein the first antenna is disposed approximately parallel to a first edge of the object, the second antenna is disposed approximately parallel to a second edge of the object, and the third antenna is disposed approximately parallel to a third edge of the object, the first, second, and third edges meeting at a common corner of the object.

9. The apparatus of claim 6, wherein the first antenna is disposed approximately diagonally to first and second edges of the object, the second antenna is disposed approximately diagonally to second and third edges of the object, and the third antenna is disposed approximately diagonally to the first and third edges of the object, the first, second, and third edges meeting at a common corner of the object.

10. The apparatus of claim 6, wherein the object is an approximately rectangular-shaped container.

11. A method, comprising
attaching a planar substrate to an object, the object comprising three sides that are approximately orthogonal to each other, the planar substrate having attached thereto a radio frequency identification (RFID) tag with at least three antennas, wherein said attaching comprises:
attaching a first portion of the planar substrate to a first of the three sides;
attaching a second portion of the planar substrate to a second of the three sides; and
attaching a third portion of the planar substrate to a third of the three sides.

12. The method of claim 11, wherein said attaching the first, second, and third portions comprises attaching such that the three antennas are approximately orthogonal to each other.

13. The method of claim 12, wherein said attaching further comprises attaching such that the first antenna is approximately parallel to a first edge of the object, the second antenna is approximately parallel to a second edge of the object, and a third antenna is approximately parallel to a third edge of the object.

14. The method of claim 12, wherein said attaching further comprises attaching such that the first antenna is approximately diagonal to a first edge of the object, the second antenna is approximately diagonal to a second edge of the object, and the third antenna is approximately diagonal to a third edge of the object.
